(19) United States
(12) Patent Application Publication
(10) Pub. No.: US 2003/0221950 A1
(43) Pub. Date: Dec. 4, 2003

(54) Plasma polymerization system and method for plasma polymerization

(76) Inventors: Sung-Hee Kang, Changwon (KR); Jeong-Kun Oh, Changwon (KR)

Correspondence Address: OSTROLENK FABER GERB & SOFFEN, 1180 AVENUE OF THE AMERICAS, NEW YORK, NY, 100368403

(21) Appl. No.: 10/221,239

(22) PCT Filed: Mar. 2, 2001
(86) PCT No.: PCT/KR01/00322

(30) Foreign Application Priority Data
Mar. 10, 2000 (KR) 2000/12101

(51) Int. Cl. B01J 19/08; B01J 19/12

(52) U.S. Cl. 204/164; 204/165; 422/186.04

(57) ABSTRACT

A plasma polymerizing system including at least one chamber is disclosed. After polymerizing a surface of a sheet by generating plasma of reactive gas in the chamber, mixed gas of oxygen and nitrogen is provided into the chamber for preventing the deterioration of the polymerizing property of the sheet. Air can be provided for the mixed gas.

### TECHNICAL FIELD

The present invention relates to a plasma polymerizing system and method thereof and the present invention provides a method and a system to maintain characteristic of the plasma polymerized substrate.

### BACKGROUND ART

If a surface of a substrate such as a steel plate is coated with a thin film using plasma, a stratum tectorium having good consistency and abrasion resistance is formed. Products having the stratum tectorium are used as a magnetic disk, optical disk, carbide tool and the like. Also, if the paint-coated film generated on the surface of a steel plate is undergone plasma processing, an unplasticized paint coated steel plate having good durability and corrosion resistance. Particularly, through the processing, quality of the surfaces can be improved increasing hydrophile and hydrophobe by polymer polymerizing the surface of the substrate, and the improved substances are widely in use.

As a typical example of the plasma polymerizing apparatus, an apparatus is disclosed in WO99/28530. In FIG. 1, the apparatus is composed of a vacuum chamber 1, and electrode 4 installed in the chamber a vacuum pumps 5, 6 for controlling pressure in the vacuum chamber, a gauge 7, 8 for measuring degree of vacuum, a power supply apparatus 8 for generating potential difference in an electrode, and a reactive gas adjusting apparatus 9, 10 for supplying unreactive gas such as reactive gas and nitrogen around the substrate.

A description of plasma polymerizing by the above apparatus is as follows.

After installing a substrate 2 in a chamber 1, the pump is started and checked whether the pressure in the chamber is maintained to be vacuous about 10⁻³ Torr with the ion gauge 8. The substrate is biased-positioned as an anode (or an active electrode) by the power supply 3 and the electrode 4 on the other side is grounded. If the pressure of the chamber is maintained as regular vacuum, reactive gas and unreactive gas are supplied around favorable places in order. The mixture ratio is controlled by the pressure of the thermocouple measurer. In case the pressure in the vacuum chamber become a certain vacuum, the vacuum chamber is discharged with direct current or high-frequency wave. Then in the plasma generated by the direct current or high-frequency wave, the molecular biding is broken and the broken chains and activated cation and anion combine thus to form a polymerized material on the surface of the substrate positioned between the electrodes.

However, in case of the apparatus above, continuous processing is not possible and accordingly, the productivity decreases. On the other hand, in the apparatus shown in Figure, continuous plasma polymerizing is possible and a polymerizing chamber 22 and post-processing chamber 23 are independent respectively differently from the apparatus in FIG. 1. The composition, which is different from the composition in which the reactive gas or unreactive gas is supplied together, can improve efficiency of the plasma polymerizing apparatus by supplying the gases separately and controlling of each gas is easy. The substrate 26 plasma polymerized in the polymerizing chamber 22 is post-processed by the reactive gas passing through the post-processing chamber 23 and through the process, hydrophile of the substrate surface can be improved.

However, the conventional plasma polymerizing apparatus has a disadvantage as follows. Gases such as oxygen, nitrogen and argon are used in the post-processing and if the substrate post-processed with the gases is left in the air, as time passes, hydrophile decreases rapidly. Namely, due to the problem that the aging characteristic decreases, quality of the product decreases and there is a bad influence to the reliability of plasma polymerizing.

### SUMMARY OF THE INVENTION

Therefore, an object of the present invention is to maintain the characteristic of the substrate surface even if time passes after plasma polymerizing. Particularly, the present invention provides a method for decreasing the reduction of hydrophile according to passing time using conventional polymerizing processing and the apparatus and reactive gas conventionally used.

In order to achieve the above object, there is provided a plasma polymerization method comprising the steps of: polymerizing a surface of a substrate generating plasma by high-voltage discharging supplying reactive gas to a polymerizing chamber; and strengthening the characteristic of the surface of the substrate generating plasma by high-voltage discharging and supplying mixed gas of oxygen and nitrogen to restrict characteristic change of a surface of a substrate deposited with polymer by polymerizing processing.

As the mixed gas of oxygen and nitrogen used as the reactive gas, air in which oxygen and nitrogen are mixed at a certain rate can be used. Also, the present invention provides a plasma polymerization system comprising: a polymerizing chamber, an electrode installed in the polymerizing chamber, reactive gas, and a substrate positioned opposite to the electrode and surface-coated by the reactive gas, which is plasma-discharged; wherein the mixture of the oxygen and nitrogen is additionally included to maintain the effects of surface processing of the substrate.

### BRIEF DESCRIPTION OF THE DRAWINGS

FIG. 1 is a schematic view showing a conventional plasma polymerizing apparatus.

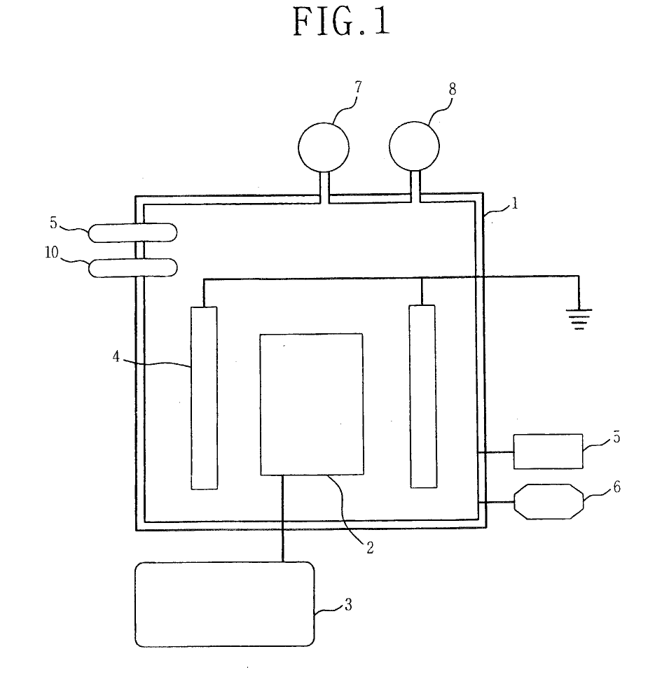

FIG. 2 is schematic view showing a plasma polymerizing continuous processing system.

FIG. 3 is a graph comparing hydrophile-maintaining effect of the method for improving hydrophile according to the present invention.

### DETAILED DESCRIPTION OF THE INVENTION

When a plasma-polymerized substrate is left in the air, as time passes, hydrophile decreases since the surface of the substrate reacts with oxygen in the air thus to be oxidized. Due to oxidization, the polymer composition of the plasma-polymerized substrate changes and the hydrophile of the substrate decreases rapidly. According to use one gas independently among oxygen, nitrogen or argon as the reactive gas, hydrophile characteristic changes and all of the results are identical on that the aging characteristic is decreased.

The present invention can prevent the surface-processing characteristic of the substrate according to passing time from decreasing. Particularly, the problem of reduction in hydrophile can be efficiently solved. At this time, it is desirable that the mixture ratio of oxygen to nitrogen is from 0.01:1 to 0.5:1. However, the ratio is not limited and it is possible to use mixed gas of nitrogen and oxygen at a certain ratio.

The polymerizing processing by the mixture of oxygen and nitrogen can be used to improve hydrophile as well as to strengthening every characteristic of the polymerized substrate such as a hydrophobe-processed and corrosion-prevented substrate.

The plasma polymerizing method is composed of the steps of polymerizing a surface of a substrate generating plasma by high-voltage discharging supplying reactive gas to a polymerizing chamber, and strengthening the characteristic of the surface of the substrate generating plasma by high-voltage discharging and supplying mixed gas of oxygen and nitrogen to improve and maintain hydrophile of a surface of a substrate deposited with polymer by polymerizing processing.

The present invention can strengthen surface processing and surface processing characteristic of the substrate by supplying the reactive gas and unreactive gas in order in the system composed of one chamber. The reactive gas and unreactive gas is supplied to separate chambers in a system having a number of chambers and the polymerizing step and strengthening step are performed in order on the path where the substrate moves.

The plasma polymerizing system is comprised of an electrode installed in the chamber, reactive gas supplied into the chamber, a polymerizing chamber having the substrate surface-coated by plasma discharging and positioned opposite to the electrode, an electrode installed in the chamber, mixed gas of oxygen and nitrogen so that the surface-coated substrate maintains the characteristic, and a strengthening chamber arranged opposite to the electrode.

It is desirable that the substrate is polymerized at the same time as it is continuously fed from the polymerizing chamber to the strengthening chamber.

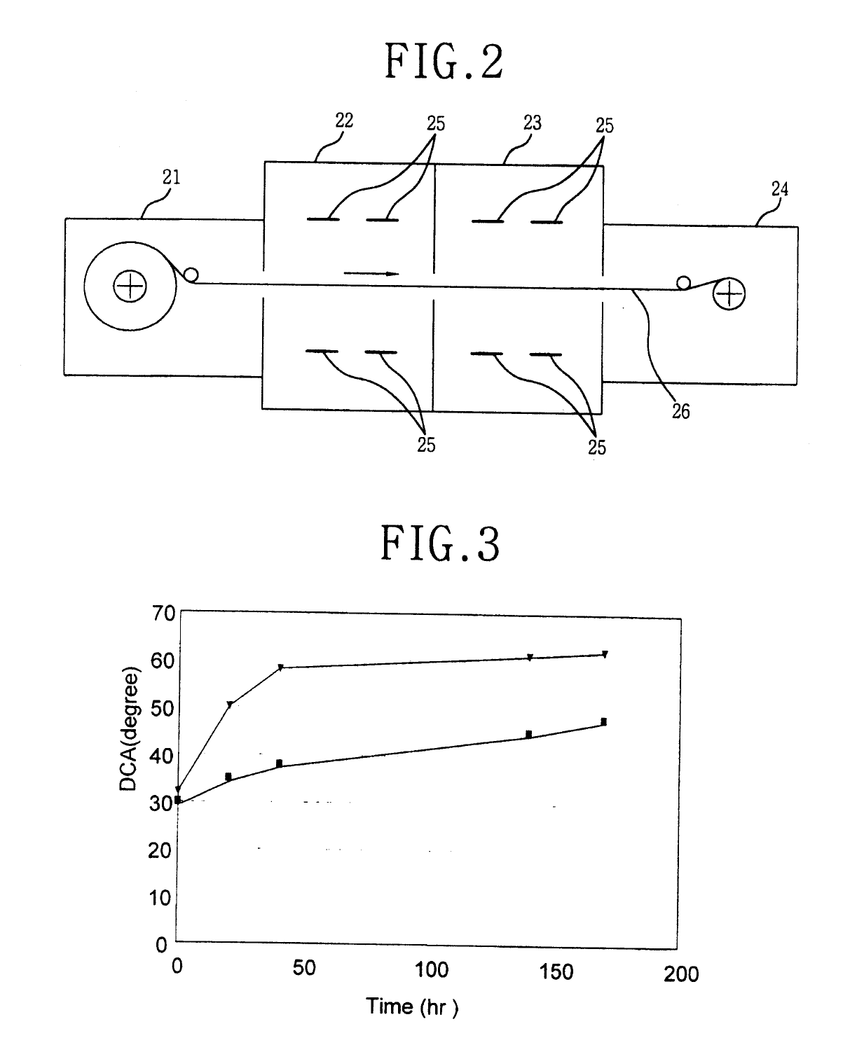

FIG. 2 shows an example of the plasma polymerizing continuous processing system in accordance with the present invention, the substrate 26 wound in the unwinding chamber 21 in the form of a roll is fed to the polymerizing chamber 22 and strengthening chamber 23 and accordingly, surface-processing is performed. Then, the substrate is again fed to the winding chamber 24 and wound in the form of a roll. Reference numeral 25 designates an opposite electrode to the fed substrate. After the polymerizing processing by supplying reactive gas in the polymerizing chamber 22, improvement of hydrophile can be obtained by continuously supplying mixed gas of nitrogen and oxygen as the unreactive gas in the strengthening chamber 23. The present invention is not limited in the continuous system wherein the polymerizing chamber and strengthening chamber are separated and the present invention can be applied in a continuous system composed in a chamber and in a noncontinuous system.

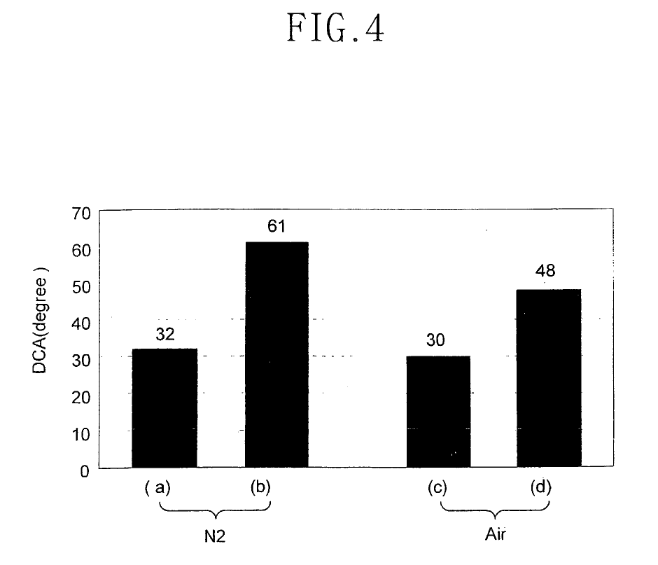

FIG. 3 shows the result of the aging experiment leaving the post-processed substrate in the air and examining change in hydrophile as time passes to verify the effect of strengthening characteristic in accordance with the present invention. As a standard of hydrophile, dynamic contact angle (DCA) is measured. A contact angle is an angle between the surface of the substrate and water and as the angle is smaller, hydrophile is better. In the drawing, upper portion is the case of post-processing nitrogen only and the lower portion is the case of mixing nitrogen and oxygen. In case of using nitrogen only, the first contact angle is larger than that of the mixed gas. However, as time passes, the contact angle increases rapidly and accordingly, after passing some time, the contact angle becomes larger than 60°. Particularly, the contact angle increases more within 50 hours.

On the other hand, in case of the mixed gas, as time passes the contact angle increases a little, but compared with the case of using nitrogen only, increase in the contact angle is largely slew down and in case the contact angle is maintained regularly after some time passes the angle is smaller than 50°. Therefore, in case of mixing nitrogen and oxygen, hydrophile and maintaining of hydrophile is improved very much.

FIG. 4 is another graph showing the effect of the present invention and it is comparing the aging characteristic of the post-processed substrate with nitrogen only and with air. The first contact angle of the surface-processed substrate and the contact after a number of wetting and drying processes are different respectively. The drying and wetting process is performed by operating 300 cycles having the substrate in the water for 10 minutes and 10 minutes in the air as one cycle. In case of processing nitrogen, the contact angle c after 300 cycles increase very much compared with the first contact angle 32, but in case of the processing of air, the contact angle d after 300 cycles is 48 and the first contact angle c is 30. Change in contact angle is not so much.

The result of the experiment is proving that the method for plasma polymerizing in accordance with the present invention can maintain the polymerizing characteristic for a long time and the maintain of the characteristic is not limited in hydrophile and the present invention can be applied to all kinds of polymerizing processing characteristic such as hydrophobe, corrosion-preventing characteristic, and surface-strengthening characteristic.

### INDUSTRIAL APPLICABILITY

As so far described, according to the present invention, hydrophile can be improved using the conventional polymerizing process and apparatus and the decrease in hydrophile on the surface of the substrate as time passes after the plasma polymerizing processing can be reduced thus to achieve improvement of quality of products and reliability.

1. A plasma polymerization method comprising the steps of:
polymerizing a surface of a substrate by generating plasma by high-voltage discharging a reactive gas supplied to a polymerizing chamber; and
strengthening the characteristic of the surface of the substrate by generating plasma by high-voltage discharging a mixed gas of oxygen and nitrogen supplied to maintain the characteristics of the surface of the substrate deposited with polymer by said polymerizing step.

2. The method of claim 1, wherein the mixed gas is air.

3. The method of claim 1, wherein the polymerizing step and strengthening step are performed in order on the path where the substrate moves.

4. A plasma polymerization method comprising the steps of:
polymerizing a surface of a substrate by generating plasma by high-voltage discharging a reactive gas supplied to a polymerizing chamber; and
strengthening the characteristic of the surface of the substrate by generating plasma by high-voltage discharging a mixed gas of oxygen and nitrogen supplied to improve and maintain hydrophile of the surface of the substrate deposited with polymer by said polymerizing step.

5. The method of claim 4, wherein the mixed gas is air.

6. A plasma polymerization method comprising the steps of:
processing of the surface of the substrate to have hydrophile by high-voltage discharging a reactive gas supplied to a polymerizing chamber; and
strengthening the surface characteristic of the substrate by generating plasma by high-voltage discharging air supplied to maintain the characteristic of the surface of the substrate.

7. A plasma polymerization system comprising:
a polymerizing chamber;
at least one electrode installed in the chamber;
a reactive gas supplied to the chamber;
a substrate positioned opposite to the electrode and coated with the reactive gas by plasma-discharging; and
a mixture of oxygen and nitrogen to be supplied to the chamber in order to maintain the effects of surface treatment of the substrate.

8. The system of claim 7, the mixture is air.

9. A plasma polymerization system comprising:
a polymerizing chamber comprising: at least one electrode installed in the chamber; a reactive gas supplied into the chamber; and a substrate coated with the reactive gas by plasma-discharging and positioned opposite to the electrode; and
a strengthening chamber comprising: at least an electrode installed in the chamber; a substrate coated with the reactive gas in the polymerizing chamber and positioned opposite to the electrode; and a mixed gas of oxygen and nitrogen to be supplied to the chamber so that the surface-coated substrate maintains the characteristic.

10. The system of claim 9, wherein the substrate is polymerized with moving continuously from the polymerizing chamber to the strengthening chamber.
